(19) United States
(12) Patent Application Publication
(10) Pub. No.: US 2005/0229892 A1
(43) Pub. Date: Oct. 20, 2005

(54) Evans easy start

(76) Inventor: Jerry Edward Evans, Mount Vernon, TX (US)

Correspondence Address: JERRY EDWARD EVANS, P.O. Box 1577, MT. VERNON, TX, 75457, US

(21) Appl. No.: 10/827,386

(22) Filed: Apr. 19, 2004

(51) Int. Cl. F02N 5/02

(52) U.S. Cl. 123/185.14

(57) ABSTRACT

The device, called “easy start” will provide a viable and convenient means for starting pull-type motors. With a hollow tube/pipe, spring inside, rope, rod or chain attached to spring, you now have the ingredients to start a pull-type motor.

### PROBLEM ANALYSIS

Pull type motors are often difficult to start.

### SOLUTION

A device which helps start pull-type motors.

### SCOPE OF INTENT

A. The device will provide a viable and convenient means for starting pull-type motors, such as lawn mowers, etc.
B. The device will consist of a hollow pipe slotted at one end to receive a lever control for hand and/or foot operation and a spring that connects to lever for operation.
C. The spring will be activated within the housing and the motor rope will be connected to the spring. A trigger mechanism will be released, pulling against the rope, thus starting the engine.
D. A rod or rope can be used to bring up the spring also-not just the lever as in “B” above (see drawing also).

### DETAILED DESCRIPTION: ROPE TYPE

The model I made consists of a PVC pipe thirty-six inches long with an eighteen-inch spring inside of the pipe. The pipe and spring length can vary; the stronger the spring, the shorter the pipe. Clip or tie a rope to the spring inside of the pipe. Pull the spring up to the end of the pipe. Place the pin through the pipe and spring. Now, one has a loaded spring within a pipe. Hook on the motor rope (engine one is starting), and pull pin. As one pulls, the spring goes back down in the pipe where it was before loading (stretching) it. This would work about the same way if permanently adapted on Briggs & Stratton engines. It would use the slotted pipe (see drawing).

### DETAILED DESCRIPTION

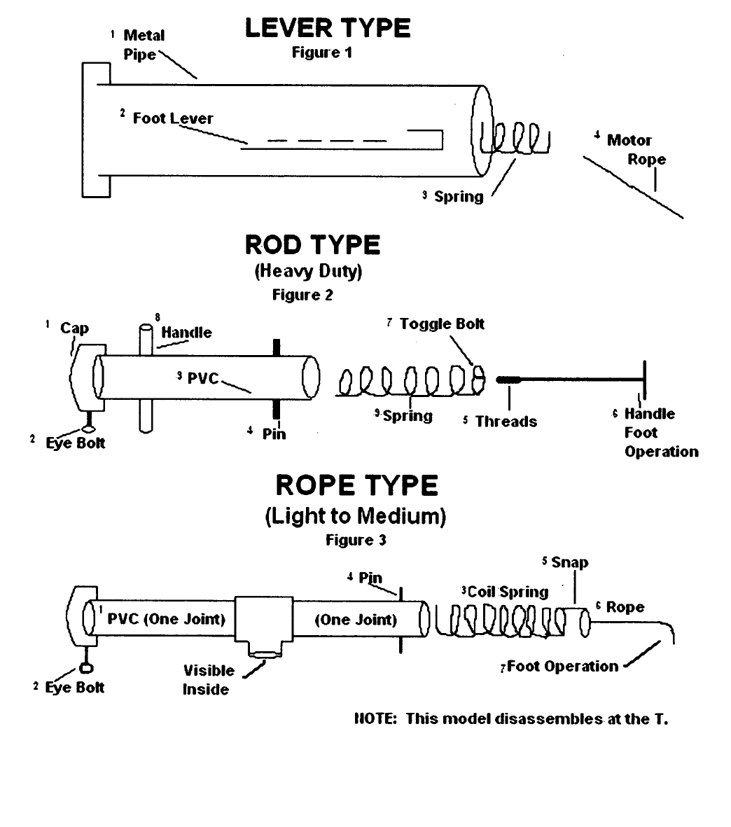

FIG. 1 #1 is a metal pipe slotted at the side for #2 Level (foot) control pedal
#3 Spring inside of pipe
#4 Motor rope to spring
Push down lever #2 foot pedal/spring #3 is attached to lever inside of pipe coming out slotted side 2-3 inches

FIG. 2 #1 capped end of #3 PVC pipe
#2 Eye bolt goes through cap and PVC pipe with #9 spring fastened to eye bolt inside of pipe
To load: Bring up spring using #6 foot operation while holding to #8 handle. Insert pin #4 through pipe and spring. It holds spring in place. Handle #6 has threads on it. Screw threads into #7 toggle bolt to bring up spring for operation.

FIG. 3 # 1 a PVC pipe (2 joints) with #2 eye bolt at end which is capped. #3 coil spring inside with a pin #4 towards the open end. #5 snap is fixed on spring from #6 rope. #7 for foot operation.

1. A hollow pipe comprising of PVC, metal, or iron with a spring inside of the pipe.

2. The apparatus of claim #1 further including a rope, rod or chain fastened to the spring.

3. I further claim a single-piece of pipe (spring inside) held in hand or permanently adapted on motors. It can/will start pull-type engines. It can either be a permanent device welded on the motor or a single piece of pipe held in one's hand for hand/foot operation.
